(19) United States
(12) Patent Application Publication
(10) Pub. No.: US 2006/0091048 A1
(43) Pub. Date: May 4, 2006

(54) Water purification system

(76) Inventor: Arthur Stephen Healey, Mansfield (AU)

Correspondence Address: DAVID A. GUERRA, 317 - 649 MARSH ROAD N.E, CALGARY, AB, T2E 5B4, CA

(21) Appl. No.: 10/545,467

(22) PCT Filed: Mar. 19, 2004
(86) PCT No.: PCT/AU04/00355

§ 371 Date: Aug. 11, 2005

(30) Foreign Application Priority Data
Mar. 19, 2003 (AU) 2003901279

(51) Int. Cl. B01D 65/00

(52) U.S. Cl. 210/110; 210/134; 210/259; 210/192; 210/266; 210/257.2

(57) ABSTRACT

A water purification system for purifying and storing drinking water, the system comprising: a pre-treatment stage for filtering untreated water to form pre-treated water, a three-way valve having an outlet and first and second inlets, each inlet having a flow regulator which regulates the flow of water into the three-way valve; a main treatment stage for treating pre-treated water by reverse osmosis or ultra-filtration to form treated water at a treated pressure; a storage stage for storing treated water in a storage vessel at a storage pressure which increases as the storage vessel is filled, the maximum storage pressure being less than equal to the treated pressure; wherein: the pre-treated water passes through the three-way valve in passage between the pre-treatment stage and the main treatment stage, the pre-treated water entering the first inlet of the three-way valve and exiting the outlet of the three-way valve; the treated water is separated into a storage stream connected to the storage stage and a recycle stream connected to the second inlet of the three-way valve; when the storage vessel is full of treated water at the maximum storage pressure, the first and second inlets of the three-way valve are closed; and when the pressure of treated water in the storage vessel is less than the maximum storage pressure, both flow regulators open until the maximum storage pressure is restored.

### SCOPE OF THE INVENTION

The present invention relates to systems for the purification of water, to the storage of the purified water, and more generally to a reservoir for storing a liquid.

### BACKGROUND OF THE INVENTION

A commercially available household water purification system consist of firstly a sponge filter to filter out sediments and bacteria, followed by a reverse osmosis (RO) membrane to remove a large proportion of the dissolved solids, followed by storage of the purified water, typically in a pressurized rubber bladder type container. However, because the bladder is made of rubber, it can only retain chlorinated water otherwise the bladder would deteriorate rapidly, and thus these systems also incorporate a carbon filter to filter the water from the storage tank before it is used for human consumption.

In these systems, water enters the various treatment units (the sponge filter, the RO membrane and the carbon filter) from their respective tops, flows down to the bottom, passes through the membrane or filter cartridges and exits the units through their tops. This configuration, however, does not utilize the entire length of the cartridges. Furthermore, the inlets and outlets in these systems are not completely sealed from one another, resulting in some transfer of water between these streams. These problems result in reduced purification of the water. Consequently, these systems typically only achieve a purity of about 30 ppm total dissolved solids (TDS).

In addition, the various units of such purification systems are constructed of plastics materials. Such materials allow slime to grow on the inner surfaces of the units. This is a particular problem in the sponge filter because, in the absence of sterilisation means, trapped bacteria in the unit can use the built-up slime as growth material. This therefore can lead to harmful levels of pathogens in the sponge filter.

The rubber bladder storage tanks are usually constructed of metal, with the rubber bladder inside. It surrounds the bladder and is typically pressurized to between 3 and 5 psi, thus acting as a driving means when water is required from the storage tank. These types of storage tanks have a number of associated problems. As was discussed above, because the bladder is made of rubber, it can only retain chlorinated water otherwise the bladder would deteriorate rapidly. Thus, further purification, by the carbon filter, is required for the water exiting the storage tank. This leads to the problem that the storage tank must at all times remain an integral part of the purification system. Another disadvantage of this storage tank is the gradual reduction in the pressure of the water delivered to the carbon filter as a consequence of the reduced elasticity of the rubber bladder over time. This problem is heightened as the porosity of the carbon cartridge is reduced by the trapped contaminants from the water exiting the storage tank. This problem of low delivery pressure is not aided by the fact that only a low air pressure can be applied to the rubber bladder because otherwise the bladder will collapse to the point where water cannot enter. Another problem with these types of storage tanks is that there is internal corrosion of the metal tank because of the entrapped moisture between the bladder and the tank.

The various treatment units are typically housed parallel to one another and are connected by a single plate bolted onto their tops. In order to gain access to one of the cartridges inside a unit, the entire apparatus has to be dismantled. This difficulty in providing maintenance to the treatment units, results in an increase in the time the purification system is offline during maintenance.

Furthermore, the units themselves, their connecting tubing, and any valves or other ancillary equipment in the purification system, are exposed to the external environment and thus can rapidly deteriorate. This increases the maintenance and replacement costs involved in operating such purification system.

### SUMMARY OF THE INVENTION

The water purification system of the present invention preferably comprises various discrete water purification steps; combinations of which are preferably conducted in series. The discrete water purification steps may include a pre-treatment step, a reverse osmosis treatment step, a carbon filtration treatment step, a silver sterilization treatment step, and a UV irradiation treatment step. The water purification steps utilised in a particular application will depend to a significant extent upon the quality of the water to be treated and the desired purity of the treated water. A typical combination for the treatment of domestic drinking water is a pre-treatment step followed by a reverse osmosis treatment step followed by a carbon filtration treatment step. The three steps are preferably conducted in discrete treatment chambers with each chamber housing an apparatus appropriate for its intended purpose.

In a first aspect, the present invention provides a water purification system for purifying and storing drinking water, the system comprising:

a pre-treatment stage for filtering untreated water to form pre-treated water;

a three-way valve having an outlet and first and second inlets, each inlet having a flow regulator which regulates the flow of water into the three-way valve;

a main treatment stage for treating pre-treated water by reverse osmosis or ultra-filtration to form treated water at a treated pressure;

a storage stage for storing treated water in a storage vessel at a storage pressure which increases as the storage vessel is filled, the maximum storage pressure being less than or equal to the treated pressure;

wherein:

the pre-treated water passes through the three-way valve in passage between the pre-treatment stage and the main treatment stage, the pre-treated water entering the first inlet of the three-way valve and exiting the outlet of the three-way valve;

the treated water is separated into a storage stream connected to the storage stage and a recycle stream connected to the second inlet of the three-way valve;

when the storage vessel is full of treated water at the maximum storage pressure, the first and second inlets of the three-way valve are closed; and

when the pressure of treated water in the storage vessel is less than the maximum storage pressure, both flow regulators open until the maximum storage pressure is restored.

A plurality of treatment chambers can be conveniently housed within a purification system housing. The housing may take the form of a cylindrical body arranged to house the plurality of treatment chambers. Preferably, the housing facilitates independent insertion and removal of the treatment chambers. Preferably, the housing also facilitates independent insertion and removal of the apparatus from each treatment chamber whilst the chamber remains housed within the housing.

The water purification system preferably includes a storage tank for storage of treated water. The storage tank may be a storage tank of known design, including conventional reservoirs having rubber bladders or diaphragms. Preferably, however, the storage tank is a storage tank in accordance with the second aspect of the present invention referred to below. It is to be understood that although the storage tank has been developed for use as an element of the water purification system of the present invention, it can readily be utilised in other applications. That is to say that the storage tank may be used for storage of liquids other than purified water of the present invention.

In a second aspect, the present invention provides a tank for storing a liquid, the tank comprising a bladderless vessel arranged to contain a gas at a gas pressure and to receive the liquid at a delivery pressure which exceeds the gas pressure, whereby receipt of the liquid in the vessel compresses the gas to store the liquid at a storage pressure which exceeds the gas pressure.

The liquid contacts the gas as it is received within the pressure vessel (ie. the liquid is not physically separated from the gas) and compresses the gas to store the liquid at a storage pressure which exceeds the gas pressure. The storage pressure will typically be somewhat less than the delivery pressure due to some absorption of the gas into the liquid.

The liquid is preferably water purified by the water purification system according to the first aspect of the present invention and the gas is preferably air or nitrogen. The gas pressure may be ambient pressure and the delivery pressure is preferably the pressure at which purified water of the present invention exits the final water purification step.

### BRIEF DESCRIPTION OF THE DRAWINGS

Preferred embodiments of the present invention will now be described, by way of example only, with reference to the accompanying drawings in which:

FIG. 1 is a schematic view of a water purification system including a storage tank;

FIG. 2 is an exploded side view of the water purification system of FIG. 1;

FIG. 3 is a cut away side view of the storage tank of FIG. 1;

FIG. 4 is a cut away side view of an alternative embodiment of the storage tank; and

FIG. 5 is a cut away side view of another alternative embodiment of the storage tank

### DETAILED DESCRIPTION OF THE DRAWINGS

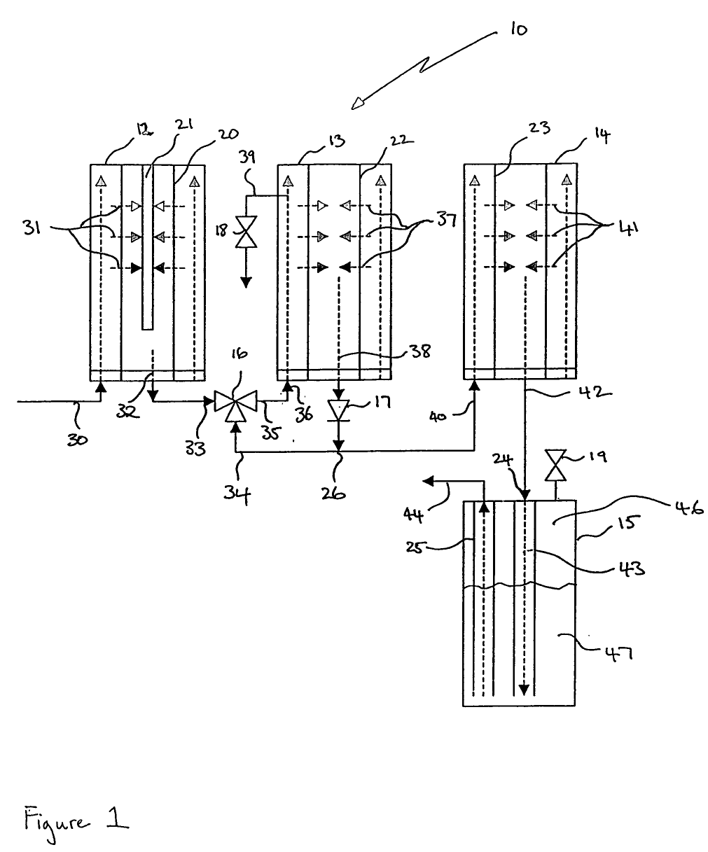

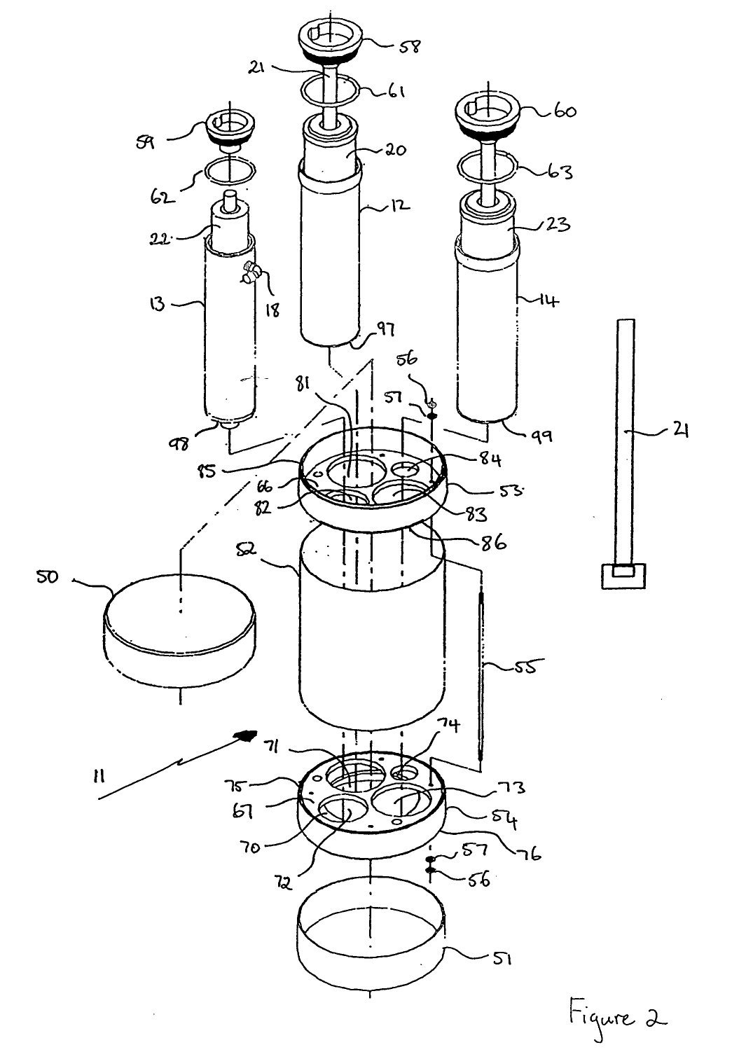

Referring firstly to FIGS. 1 and 2, a water purification system 10 has a pre-treatment chamber 12, a main treatment chamber 13, a carbon filter chamber 14 and a storage tank 15. The pre-treatment chamber 12 is substantially cylindrical and houses a sponge filter cartridge 20. The pre-treatment cartridge 20 is an annular substantially spun polypropylene filter with a pore size of approximately 1μ. In use, the pre-treatment cartridge 20 acts to remove organic and particulate material from the water. The pre-treatment chamber 12 also houses a silver anode 21, located within the central core of the pre-treatment cartridge 20. The silver anode 21, in use, kills substantially all of the bacteria in the water 31 passing through the cylindrical core of the pretreatment cartridge 20. Silver ions leave the silver anode 21 by dissolving into the water. The low solubility of silver in water acts as a controlled release mechanism so that only trace amounts (below the level which risks human health and environmental damage) of silver are ever present in the water. The presence of trace amounts of silver in water is known to have a sterilisation effect.

Once in the water, the silver ions permeate through the water in the cylindrical core of the pretreatment chamber 12 and through the pretreatment cartridge 20, thus preventing the build-up of pathogens within the cartridge 20. The silver ions remain in the water as it travels downstream, thus having a continual sterilisation effect throughout the purification system 10. The pre-treatment chamber 12 is sealed from the external environment by a removable end cap 58 and its corresponding O-ring 61 at the top of the pretreatment chamber 12, and by a welded plate 97 at the bottom of the pretreatment chamber 12.

The main treatment chamber 13 is also substantially cylindrical and houses a membrane 22. The main treatment membrane 22 is an annular spiral wound membrane. The main treatment membrane 22 has a porosity of 1-10 Å and thus in use acts to remove a substantial amount of the dissolved solids from the water. The main treatment membrane 22 can be, for example, a Dow Filmtec® TN30-18120-50 RO Reverse Osmosis membrane (polyamide membrane) or a Desal® CA-Series RO Membrane (triacetate/diacetate blend membrane). Alternatively, the main treatment membrane 22 could be a UF membrane. Although a UF membrane cannot achieve the same purity levels as a RO membrane, it has other advantages which will become apparent further on in the specification. Notably, if a RO membrane is used, the water purification system 10 can be used as a de-salination plant.

The main treatment chamber 13 is sealed from the external environment by a removable end cap 59 and its corresponding O-ring 62 at the top of the main treatment chamber 13, and by a welded plate 98 at the bottom of the main treatment chamber 13.

The carbon filter chamber 14 is substantially cylindrical and houses an annular carbon filter 23. In use, the carbon filter 23 acts as a final purification stage to substantially remove any remaining odours and/or colours from the water. The carbon filter 23 can be, for example, a KX Matrikx® PB1 #06-250-125-975 2 Micron Extended Carbon Block Water Filter. The carbon filter chamber 14 is sealed from the external environment by a removable end cap 60 and its corresponding O-ring 63, at the top of the carbon filter chamber 14, and by a welded plate 99 at the bottom of the carbon filter chamber 14.

The pre-treatment chamber 12, the main treatment chamber 13 and the carbon filter chamber 14 are conveniently and compactly stored in a purification system housing 11. The purification system housing 11 consists of a cylindrical body 52 with top and bottom caps 50 and 51, respectively. The purification system housing 11 also has top and bottom holding portions, 53 and 54 respectively, which in use act to hold the pre-treatment chamber 12, the main treatment chamber 13 and the carbon filter chamber 14 in fined upright positions. The top and bottom holding portions 53 and 54 are located at the respective top and bottom ends of the cylindrical body 52 of the purification system housing 11. A plurality of reinforcing rods 55 are connected at their respective top and bottom ends to the top and bottom holding portions 53 and 54 using threaded nuts 56 and washers 57 or the like. The reinforcing rods 55 are located internally of the cylindrical body 52 and in use provide added support and strength to the purification system housing 11.

The bottom holding portion 54 is substantially cylindrical and has an upper circumferential lip 75 and a lower circumferential lip 76. The diameter of the upper circumferential lip 75 of the bottom holding portion 54 is sized so as to receive and form a friction fit with the bottom end of the cylindrical body 52. The inner diameter of the bottom cap 51 is sized to receive and form a friction fit with the lower circumferential lip 76 of the bottom holding portion 54. These friction fits provide a seal from the external environment.

The bottom holding portion 54 has a circular plate 67, located towards the upper circumferential lip 75. The resulting space between the circular plate 67 and the bottom cap 51, in use, contains various connection tubes and valves between the pretreatment chamber 12, the main treatment chamber 13 and the carbon filter chamber 14. The circular plate 67 has a number of apertures 71, 72, 73 and 74 formed therein. Apertures 71, 72 and 73 are sized so as to form a friction fits with the pre-treatment chamber 12, main treatment chamber 13 and carbon filter chamber 14, respectively. The other aperture 74 is sized to receive and form a friction fit with an optional UV tube (not shown).

The bottom holding portion 54 further includes an annular plate 70 which is either integrally formed with or otherwise connected to the underside of the circular plate 67. The annular plate 70 partially occludes the apertures 71, 72, 73 and 74 in the circular plate 67 so that, in use, the pre-treatment chamber 12, the main treatment chamber 13 and the carbon filter chamber 14 fit through their respective apertures 71, 72 and 73 to abut against portions of and be supported by the annular plate 70. The pre-treatment chamber 12, main treatment chamber 13 and carbon filter chamber 14 are connected to the bottom holding portion 54 by bolting or the like to the annular plate 70.

The top holding portion 53 is substantially cylindrical and has an upper circumferential lip 85 and a lower circumferential lip 86. The diameter of the upper circumferential lip 85 of the top holding portion 53 is sized so as to be received in and form a friction fit with the top cap 50. The diameter of the lower circumferential lip 86 of the top holding portion 53 is sized so as to receive and form a friction fit with the top end of the cylindrical body 52. These friction fits provide a seal from the external environment.

The top holding portion 53 has a circular plate 66, located towards the lower circumferential lip 86. The resulting space between the circular plate 66 and the top cap 50, in use, contains various connection tubes and valves between the pretreatment chamber 12, the main treatment chamber 13 and the carbon filter chamber 14. The circular plate 66 has a number of apertures 81, 82, 83 and 84 formed therein. Apertures 81, 82 and 83 are sized so as to form a friction fit with the pretreatment chamber 12, main treatment chamber 13 and carbon filter chamber 14 respectively. The other aperture 84 is sized to receive and form a friction fit with a range of different additional stages (not shown). These additional stages are included to fulfill various different requirements to treat different waters having different impurities. Examples of these additional stages include UV sterilisation, phosphate removal, lead removal, etc.

The purification system housing 11 and, in particular, the top and bottom holding portions 53 and 54, provide a sturdy and compact structure, which is sealed from the external environment, in which the pretreatment chamber 12, the main treatment chamber 13 and the carbon filter chamber 14 are neatly contained. Furthermore, the caps 50 and 51 and the top and bottom holding portions 53 and 54 allow for ready access within, and easy maintenance of, the purification system 10. The pretreatment chamber 12, the main treatment chamber 13 and the carbon treatment chamber 14 can be removed individually from the purification system housing 11 by disconnection from the annular plate 70 and subsequent slidable removal from the top and bottom holding portions 53 and 54.

Furthermore, the pretreatment cartridge 20, the silver anode 21, the main treatment membrane 22 and the carbon filter 23 can be removed from their respective chambers 12, 13 and 14, without removing any of the chambers 12, 13, and 14 because the chambers 12, 13 and 14 are securely connected to the bottom holding portion 54 and in particular to the annular plate 70. This can be achieved by removing end caps 58, 59 or 60 from their respective chambers 12, 13 or 14 and removing or inserting therein the pretreatment cartridge 20, the silver anode 21, the main treatment membrane 22 and the carbon filter 23 respectively. During this process the chambers 12, 13 and 14 remain secured within the purification system housing 11.

In use, the water purification system 10 receives water under mains pressure (typically 70 to 100 psi). However, water could be received at a pressure of as low as 40 psi (if a RO membrane is used in the main treatment chamber 13) or even as low as 10 psi (if a UF membrane is used in the main treatment chamber 13). The water purification system 10 could also receive water which is pumped from a stagnant water source such as a tank or a well by a pump (not shown).

The water enters the purification system 10 through an inlet 30 located toward the rim of the bottom of the pretreatment chamber 12. The water passes upwardly to occupy the annular space between the inner surface of the pretreatment chamber 12 and the outer surface of the pretreatment cartridge 20. The water then passes through the pretreatment cartridge 20 by filtration, and the resulting filtrate 31 flows down through the cylindrical core of the pretreatment cartridge 20. The filtrate 31 is sterilized by the silver anode 21 located in the core of the pretreated cartridge 20.

As will be described further on, a similar flow path is used in the main treatment chamber 13 and the carbon filter chamber 14. The advantage of this flow path is that it utilises the entire length of the pretreatment cartridge 20, the main treatment membrane 22 and the carbon filter 23, to filter out impurities. Furthermore, it means that the pretreatment cartridge 20 and the main treatment membrane 22 are filled with water and thus don't dry out. If the membranes used for the pretreatment cartridge 20 and the main treatment membrane 22 were to dry out they would deteriorate and eventually fail.

The pretreatment cartridge 20 is not of a kind arranged for periodic removal, cleaning and replacement. Rather, it is arranged for replacement after its efficiency has dropped below a predetermined level.

Water exits the pretreatment chamber 12 through an outlet 32 located centrally of the base of pretreatment chamber 12 before entering a first inlet 33 of a three-way control valve 16. The three-way control valve 16 has a single outlet 35 which has a pressure similar to the pressure of the first inlet 33.

The water exiting the outlet 35 of the three-way control valve 16 enters the main treatment chamber 13 through an inlet 36 towards the rim of the bottom of the main treatment chamber 13. The water passes upwardly to occupy the annular space between the inner surface of the main treatment chamber 13 and the outer surface of the main treatment membrane 22. Water then passes through the main treatment membrane 22 by reverse osmosis. The resulting filtrate 37 flows down the cylindrical core of the main treatment membrane 22 and out of the main treatment chamber 13 through an outlet 38 located centrally of the base of the main treatment chamber 13.

At the top of the inlet side of the main treatment chamber 13 there is provided a low pressure stream 39 which is controlled by a restrictor 18. The restrictor 18 provides a local region of pressure which is lower than the inlet pressure at the top of the main treatment membrane 22. This causes the water entering the main treatment membrane 22 to be sucked up to the top of the main treatment membrane 22 by capillary action. A proportion of the water entering the main treatment chamber 13 exits through the lower pressure stream 39. The ratio of the pressures in the lower pressure stream 39 to the outlet 38 is dependent upon the type of membrane 22 used and can vary. Typically, the ratio will be between 1:1 and 1:5. The pressure provided by the restrictor is typically about 40 psi. Operating at this pressure assists in preventing failure of the main treatment membrane 22 which will typically have a pressure rating in the order of 100 psi. However, alternative membranes, with pressure ratings of up to 3000 psi can be used and in such cases the pressure restriction of the restrictor 18 can be configured to provide a greater pressure in the membrane.

The restrictor 18 typically comprises either a capillary tube or, as depicted in FIG. 2, a 90° valve. The 90° valve is screwed into either the top of the main treatment chamber 13 or into the end cap 59 such that it is external to the main treatment chamber 13. This allows for ease of service of the restrictor 18 as there is no need to dismantle the main treatment chamber 13 to access the restrictor 18.

For the restrictor 18 to operate with most commercially available RO membranes, including those mentioned previously, the membranes require modification to relocate their sealing ring to below the level at which water exits the main treatment chamber 13 through the lower pressure stream 39. The water exiting the main treatment chamber 13 through the lower pressure stream 39 goes to waste.

The effect of the restrictor 18 sucking water up to the top of the main treatment membrane 22 is that water is constantly washing through the membrane 22. This results in constant cleaning of the membrane 22 and removal of the membrane's retentate through the lower pressure stream 39. This in turn results in there being no need to have a separate cleaning process for the main treatment membrane 22 either in situ or after removing the membrane 22. This constant cleaning process also results in extending the life of the membrane 22.

If a UF membrane is used in the main treatment chamber 13, then the low pressure stream 39 and the restrictor 18 are not required. Rather the water simply passes through the UF membrane in a similar manner to the pretreatment cartridge 20. This is highly advantageous where water needs to be conserved (such as in a third world country) because with the UF membrane no water entering the main treatment chamber 13 is wasted. It does mean, however, that the UF membrane is not self-cleaning like the RO membrane. Thus, the main treatment membrane 22, if a UF membrane has to be replaced more often.

The water exiting the main treatment chamber 13 through the outlet 38 passes through a non-return valve 17. The non-return valve 17 prevents any backflow of water into the main treatment chamber 13 by slightly dropping the pressure (generally by about another 10 psi). After passing through the non-return valve 17 the water is split by a splitter 26. One fraction of the water flows to a second inlet 34 of the three-way control valve 16. Thus, this fraction of water from the splitter 26 will be recycled through the main treatment chamber 13.

The other fraction of water from the splitter 26 enters the carbon filter chamber 14 through an inlet 40 located towards the rim of the bottom of the chamber 14. The water passes upwardly to occupy the annular space between the inner surface of the carbon filter chamber 14 and the outer surface of the carbon filter 23. Water then passes through the carbon filter 23 and the resulting filtrate 41 flows down through the cylindrical core of the carbon filter 23 to exit the carbon filter chamber 14 through an outlet 42 located centrally of the base of the chamber 14. The water exiting the carbon filter chamber 14 has a total dissolved solids (TDS). concentration of as low as 0.003 ppm. The carbon filter 23 is not cleaned or reactivated, but instead is replaced after its efficiency has dropped below a predetermined level.

In an alternative embodiment, the water exiting the carbon filter chamber 14 is further treated by a UV tube (not shown) for further purification prior to exiting the purification system housing 11.

From the outlet 42 of the carbon filter chamber 14 the water enters the storage tank 15 through an inlet 24 at the top of the storage tank 15. The water passes down through an inlet tube 43 to fill the tank 15 from the bottom. The storage tank 15 is sealed from the external environment and thus the water 47 filling the tank 15 compresses the ambient pressure air 46 already present in the tank 15. Water exits the tank 15 as required from the bottom of the tank 15 by passing up through an outlet tube 25. The exiting water is driven by the pressure of the air 46 in the tank 15 which has been pressurised as a consequence of compression by the incoming water to the tank 15. The water outlet 44 from the storage tank 15 may be controlled by a faucet (not shown) affixed directly to the storage tank 15. Alternatively, the water may exit the outlet 44 and then pass through tubing or the like.

Connected to the storage tank 15 is an air valve 19, which in use is generally closed. However, it may be opened to introduce additional air into the storage tank 15, for example, to replace air in the tank 15 which has been lost through absorption of the air into the water. The air valve 19 can also be used to empty the tank 15 by pumping extra air through the air valve 19 into the tank 15. If this is done with the faucet at the water outlet 44 open, then the air pumped into the tank 15 displaces the water and forces it out through the water outlet 44. Once all or almost all of the water has been forced out, air will start exiting the water outlet 44 and the pressure in the tank 15 will go to atmospheric pressure and the tank 15 will be ready to be filled again. It may be desirable for a consumer to empty the tank 15 in this way when, for example, the water in the tank 15 is contaminated. Thus, the storage tank 15 is self-serviceable. Alternatively, this process could be done using an inert gas which is harmless to human consumption such as nitrogen (N₂).

The maximum pressure in the storage tank 15 will be equal to the pressure at the outlet of the non-return valve 17 less any system losses between the outlet of the non-return valve 17 and the inlet 43 to the storage tank 15 (eg. the pressure drop across the carbon filter 23). Thus, as the pressure at outlet of the non-return valve 17 is controlled to be approximately 30 psi, the maximum storage pressure in the storage tank 15 will be slightly less than approximately 30 psi. At this pressure, the tank 15 can be filled with water to approximately 80% of its total volume.

The three-way control valve 16 has a diaphragm on its first inlet 33 and a diaphragm on its second inlet 34. These diaphragms regulate the flow of water through the three-way control valve 16. Thus, the three-way control valve 16 acts to control the filling and refilling processes of the storage tank 15.

When the tank 15 is empty, the diaphragms are fully open. However, because the second inlet 34 to the three-way control valve 16 has a much lower pressure than the first inlet 33, (the pressure at the second inlet 34 is approximately equal to the pressure in the tank 15) , the flow of water through the second inlet 34 is minimal. As water begins to fill the tank 15, the pressure inside the tank 15 increases. Consequently, the pressure in the second inlet stream 34 to the three-way control valve 16 increases. This process continues until the tank 15 reaches a maximum storage pressure. At this point the pressure at the splitter 26 and hence at the second outlet 34 and the outlet from the non-return valve 17, is approximately equal to the maximum storage pressure. The diaphragm at the second outlet 34 detects that the maximum storage pressure has been reached causing both the diaphragms to completely close. There is now a zero flow rate at the outlet 35 of the three-way control valve 16 and consequently a zero flow rate at the inlet 43 of the storage tank 15. Without the diaphragm at the second outlet 34 this would not occur because even though the full tank 15 would prevent any flow through the main treatment membrane 22, the low pressure region created by the restrictor 18 at the top of the main treatment chamber 13 would continue to suck water through the annular space between the membrane 22 and the inner wall of the main treatment chamber 13 (ie. the diaphragm at the first inlet 33 would never close). This would result in a constant stream of water going to waste whilst the tank 15 was full.

For a tank 15 with a total volume of 5 L, this filling process takes approximately 10 minutes.

When water is removed from the storage tank 15, the pressure in the tank 15 reduces. This causes the pressure at the splitter 26 and hence at the second inlet 34 of the three-way control valve 16 and the outlet of the non-return valve 17 to be reduced. This results in the diaphragms at both the second inlet 34 and the first inlet 33 of the three-way control valve 16 to be opened and for water to be drawn through the non-return valve 17 and thus through the main treatment membrane 22. The tank 15 is then refilled in the same way as described above until it reaches its maximum storage pressure once again.

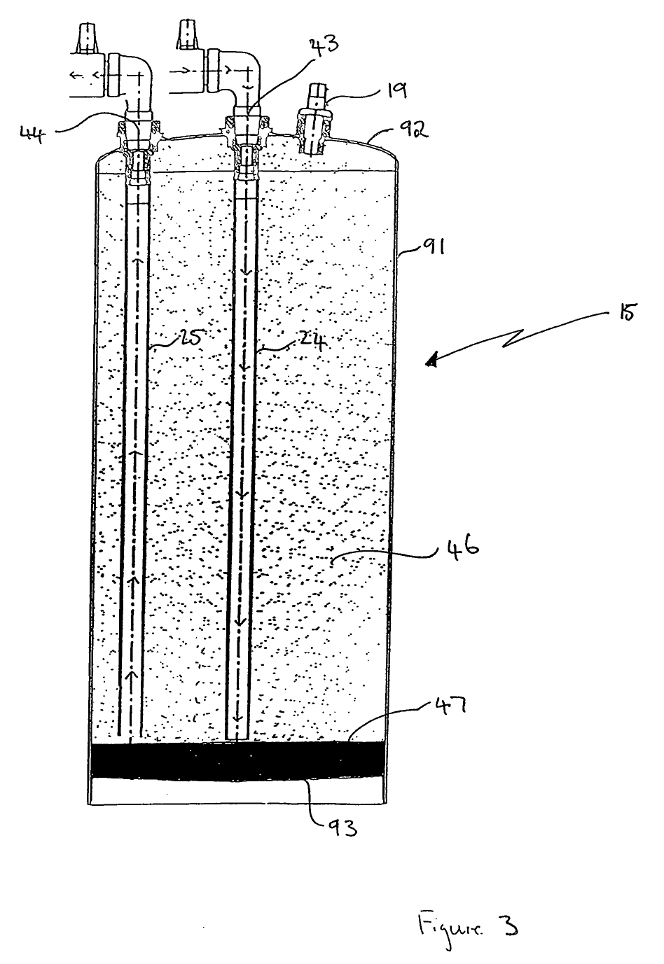

Referring now to FIG. 3, the storage tank 15 comprises a cylindrical body 91. Welded to the top of the cylindrical body 91 is a top sealing plate 92 and welded to the bottom of the cylindrical body 91 is a bottom sealing plate 93. Top and bottom sealing plates 92 and 93 seal the inside of the storage tank 15 from the external environment.

The inlet 43 to the tank 15 comprises a threaded bush which passes through an aperture in the top plate 92, located substantially towards the centre of the top plate 92. The threaded bush of the inlet 43 forms a seal with the top plate 92, thus retaining the integrity of the storage tank 15. The threaded bush of the inlet 43 is connected to the inlet tube 24 which extends for substantially the length of the cylindrical body 91, thus delivering the incoming water to the storage tank 15 to the bottom of the tank 15 proximate to the bottom sealing plate 93. A one way return valve (not shown) may be connected to the inlet 43 so as to prevent any loss of water 47 or air 46 from the tank 15 through the inlet 43.

The outlet 44 to the tank 15 comprises a threaded bush which passes through an aperture in the top plate 92, located substantially towards the rim of the top plate 92. The threaded bush of the outlet 44 forms a seal with the top plate 92, thus retaining the integrity of the storage tank 15. The threaded bush of the outlet 44 is connected to the outlet tube 25 which extends for substantially the length of the cylindrical body 91, thus it takes the outgoing water from the storage tank 15 from the bottom of the tank 15 proximate to the bottom sealing plate 93. The outlet tube 25 is slightly shorter than the inlet tube 24 so that its end proximate to the bottom sealing plate 93 is slightly further away from the bottom sealing plate 93 than the corresponding end of the inlet tube 24. This arrangement helps prevent the loss of gas from the tank 15.

The inlet and outlet tubes 24, 25 may be silver plated copper. The silver provides sterilisation for the water. In addition the Ag/Cu tubes help prevent corrosion of the tank 15 by acting as a sacrificial anode. Once the tubes 24, 25 become overly worn they can be easily replaced by disconnecting the tubes 24, 25 from their respective threaded bushes, thus avoiding the need to replace the entire tank 15.

The air valve 19 passes through an aperture in the top plate 92 and is located substantially towards the rim of the top plate 92. The air valve 19 forms a seal with the top plate 92, thus retaining the integrity of the storage tank 15.

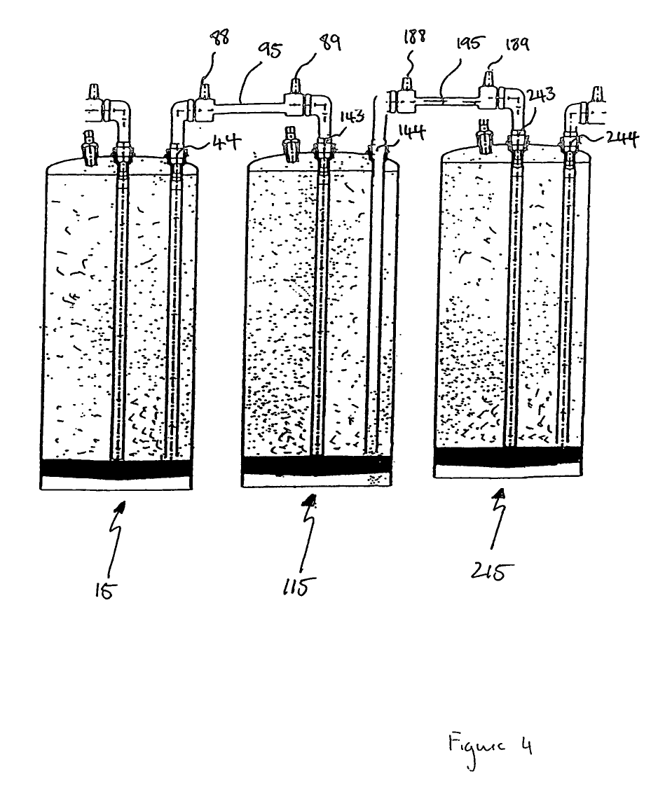

Referring now to FIG. 4, storage tank 15 is connected in series with a similar second storage tank 115 and a similar third storage tank 215.

The outlet 44 of the storage tank 15 is connected by connection portion 95 to the inlet 143 of the second storage tank 115. Similarly the outlet 144 of the second storage tank 115 is connected by a connection portion 195 to the inlet 243 of the third storage tank 215. The outlet 244 of the third storage tank 215 may be connected to yet another similar storage tank, and so on for as many tanks as required. In use, some of the water filling the first tank 15 exits through the outlet 44 to subsequently begin filling the second tank 115. In turn, some of the water filling the second tank 115 exits through outlet 144 to begin filling the third tank 215. Alternatively, the first tank 15 can be filled first by closing valves 88 and/or 89 on the connection portion 95. Once the first tank 15 has reached capacity, valves 88 and 89 can be opened to begin filling the second tank 115, keeping valves 188 and/or 189 shut. This process may continue for as many tanks as required. In either of the above-described approaches, the storage capacity can be easily increased by the connection of multiple tanks in series.

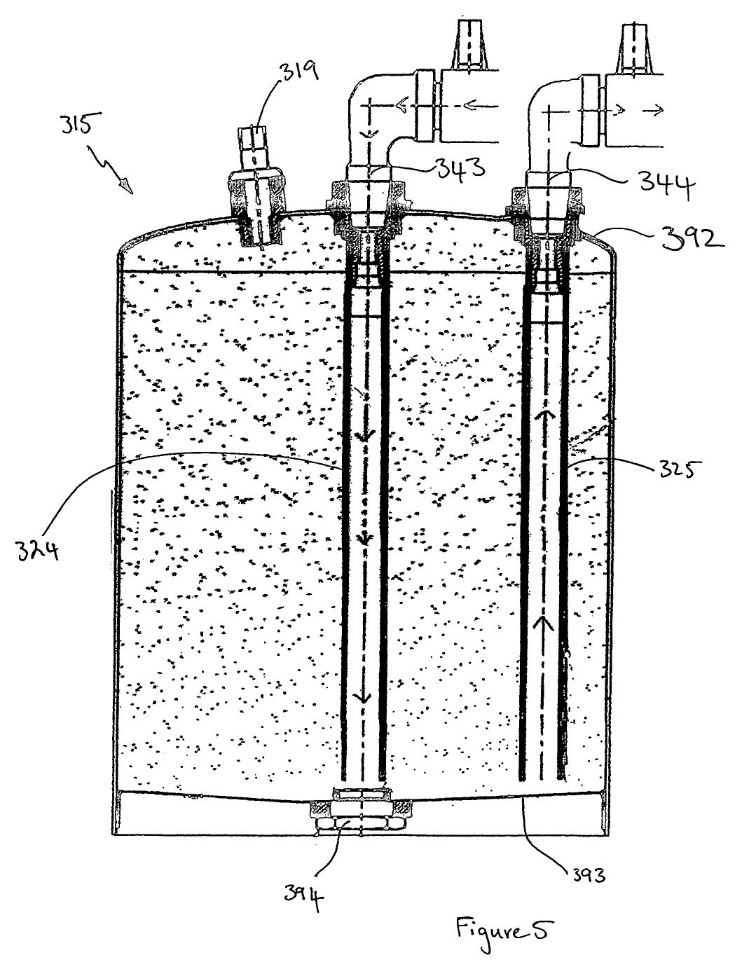

Referring now to FIG. 5, a similar storage tank 315 is provided with an inspection plug 394 in the bottom sealing plate 393. The inspection plug 394 provides an alternative means for draining the tank 315 to pumping air through the air valve 319. This is because the plug 394 can be simply removed to let the water drain out through the bottom of the tank 315. Furthermore, with inspection plug 394 removed and the tank 315 drained, the inside of the tank 315 can be checked and/or cleaned through the aperture in the bottom sealing plate 393 in which the plug 394 in normal use fits.

In general, it is desirable to regularly clean the storage tank 315 to avoid the build-up of slime, scale and possible corrosion and to ensure the integrity of both. the tank 315 and the water it stores. This is usually done by draining the tank 315 using either the air valve 319 or the inspection plug 394. The threaded bushes for the air valve 319 and the water inlet 343 and outlet 344 can then be unscrewed from the top plate 392, and the air valve 319, the inlet tube 324 and the outlet tube 325 removed from the tank 315. The inlet and outlet tubes 324, 325 may then be also unscrewed from their respective threaded bushes for separate cleaning and/or replacement. The inside of the tank 315 can then be mechanically cleaned through one or more of the various apertures in the tank. The tank 315 is then reassembled, purged with a gas which is harmless to human consumption such as N₂ and reconnected to the water purification system 10.

The tank 315 may also have a carbonator (not shown) attached to the water inlet 343 to carbonate the water entering the tank 315 by injecting CO₂.

The various structural components of the purification system 10, and in particular the purification system housing 11, the pre-treatment chamber 12, the main treatment chamber 13, the carbon filter chamber 14 and the storage tank 15, are constructed of stainless steel. Stainless steel is a cost effective material of construction for pressure vessels. Furthermore, stainless steel does not readily corrode, and also is resistant to the growth of slime on the inner surfaces of the pre-treatment chamber 12, the main treatment chamber 13, the carbon filter chamber 14 and the storage tank 15. In addition, the inner surfaces of the main treatment chamber 13, the carbon filter chamber 14 and the storage tank 15 can be coated with silver in order to enhance sterilisation of the water within those chambers.

The most important result of using these materials of construction is that there is no need for any purification of the water 44 exiting the storage tank 15. However, it is possible to construct the aforementioned elements of the purification system 10 of other materials, and in particular of plastic materials. A purification system 10 having all its elements constructed of plastic may be disposable, and is thus entirely replaced periodically. The disposable purification system 10 comprises the pretreatment chamber 12, the main treatment chamber 13 housing a UF membrane and the carbon filter chamber 14, all fully enclosed and sealed in the purification system housing 11.

In the claims which follow and in the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

Modifications and improvements may be incorporated without departing from the scope of the present invention.

1. A water purification system for purifying and storing drinking water, the system comprising:
a pre-treatment stage for filtering untreated water to form pre-treated water;
a three-way valve having an outlet and first and second inlets, each inlet having a flow regulator which regulates the flow of water into the three-way valve;
a main treatment stage for treating pre-treated water by reverse osmosis or ultra-filtration to form treated water at a treated pressure;
a storage stage for storing treated water in a storage vessel at a storage pressure which increases as the storage vessel is filled, the maximum storage pressure being less than or equal to the treated pressure;
wherein:
the pre-treated water passes through the three-way valve in passage between the pre-treatment stage and the main treatment stage, the pre-treated water entering the first inlet of the three-way valve and exiting the outlet of the three-way valve;
the treated water is separated into a storage stream connected to the storage stage and a recycle stream connected to the second inlet of the three-way valve;
when the storage vessel is full of treated water at the maximum storage pressure, the first and second inlets of the three-way valve are closed; and
when the pressure of treated water in the storage vessel is less than the maximum storage pressure, both flow regulators open until the maximum storage pressure is restored.

2. A system as claimed in claim 1 further comprising a post-treatment stage for further treating the treated water prior to the storage stage.

3. A system as claimed in claim 2 wherein the post-treatment stage comprises a carbon filtration stage.

4. A system as claimed in claim 2 wherein the post-treatment stage comprises a carbon filtration stage followed by a UV treatment stage.

5. A system as claimed in any one of the preceding claims wherein the main treatment stage is performed in a main treatment chamber which houses a reverse osmosis membrane, the pre-treated water occupying a space between an inner surface of the main treatment chamber and the outer surface of the membrane prior to passage through the membrane by reverse osmosis.

6. A tank for storing a liquid, the tank comprising a bladderless vessel arranged to contain a gas at a gas pressure and to receive the liquid at a delivery pressure which exceeds the gas pressure, whereby receipt of the liquid in the vessel compresses the gas to store the liquid at a storage pressure which exceeds the gas pressure.

7. A system as claimed in any one of claims 1 to 5 wherein the storage vessel is a tank as claimed in claim 6.
